(19) United States
(12) Patent Application Publication
(10) Pub. No.: US 2008/0228856 A1
(43) Pub. Date: Sep. 18, 2008

(54) INFORMATION PROCESSING DEVICE DETECTING OPERATION, ELECTRONIC EQUIPMENT AND STORAGE MEDIUM STORING A PROGRAM RELATED THERETO

(75) Inventor: Shoichi Sano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/127,196

(22) Filed: May 27, 2008

Related U.S. Application Data
(63) Continuation of application No. PCT/JP2005/022004, filed on Nov. 30, 2005.

(51) Int. Cl. G06F 13/00; G06F 15/16

(52) U.S. Cl. 709/201

(57) ABSTRACT

An information processor comprises an image sender for sending an image including the image section of an operation object element displayed and operated on an electronic device to the electronic device, a detection information receiver for receiving operation detection information indicating that the image section is operated on the electronic device, a detector for detecting the operation object element corresponding to the image section according to the detection information, and a processor for executing the processing step required in response to the operation to the operation object element.

### CROSS-REFERENCE TO RELATED APPLICATION

This is a continuation of Application PCT/JP2005/022004, filed on Nov. 30, 2005, now pending, the contents of which are herein wholly incorporated by reference.

### BACKGROUND

Description of the specification relates to an information processing device.

Nowadays, at Websites on the Internet, a large quantity of various categories of information are supplied mainly to personal computers. On the other hand, mobile equipment such as mobile phones and mobile information terminals other than the personal computers has spread as information equipment for accessing the various categories of information. Hence, there is a request for the mobile equipment to browse pages (contents) on the Web (Internet).

The mobile equipment has, however, the following problems. One problem is that a screen is small, has a low resolution and is therefore hard to see. Further, the Browser for the mobile equipment is restricted in terms of a capability of the CPU and a memory capacity as well, and has problems in terms of performance and function as compared with the personal computer. Especially, links to Web pages are attached with images in many cases. In this case, if a data volume for transmission is large, the problems are the CPU performance and the communication performance of the mobile equipment. Yet another problem is that the mobile equipment has a small number of usable functions such as there being a small number of installation-enabled computer programs due to the restrictions of the CPU performance and the memory capacity.

Such being the case, a solution of the problem in terms of the performance is, for example, a technology proposed for reducing the data quantity for transmission by transforming the link display within the Web page into text information specifying not the image but a link destination. This scheme aims at reducing the data quantity by replacing some proportion of the images having the large data quantity with the texts.

According to this technology, however, if the mobile equipment requests for want-to-utilize functions (e.g., a display function based on a Web content generating program, and a data display/edit function based on a spreadsheet program), the mobile equipment, which does not implement any program for actualizing these functions, is unable to utilize these functions. Accordingly, this technology can not solve the problem of how the functions utilizable to the low-performance mobile equipment are extended. Namely, even in the case of the mobile equipment's performance being limited, there is no fundamental measure for an object of desiring to provide the users with the ample functions.

Proposed further is a technology of eliminating futility by identifying the contents acceptable to the mobile equipment and transmitting none of reception-disabled/display-disabled contents to the mobile equipment. This technology is, however, a method of deleting the unnecessary data, wherein the functions not supported by the mobile equipment can not still be executed by the mobile equipment.

Moreover, for simplifying the Web page to be transmitted to the mobile equipment, there is proposed a technology of detecting a difference from the Web page accessed in the past and a difference from the Web page of which URL is neighboring, and transmitting only the differences to the mobile equipment. This scheme is effective as a solution to a communication environment having a narrow line bandwidth or to a small screen of the mobile equipment. In this technology also, however, as in the case of the prior arts described above, the functions not supported by the mobile equipment can not be executed. Furthermore, even in the case of the mobile equipment's performance being limited, there is no fundamental measure for the object of desiring to provide the users with the ample functions.

### SUMMARY

It is an object to realize a processing environment of a computer capable of providing, in electronic equipment having a lower throughput and a less number of usable functions than a normal computer, higher performance and more of functions than the electronic equipment.

One aspect of the present invention is illustrated by the following an information processing device. Namely, the information processing device comprising: an image transmitting unit transmitting an image including an image segment of an operation target element that is displayed and operated on electronic equipment to the electronic equipment; a detection information receiving unit receiving detection information indicating that the image segment is operated on the electronic equipment; a detecting unit detecting the operation target element corresponding to the image segment from the detection information; and a processing unit executing a processing step that should be executed with respect to the operation on the operation target element.

According to the information processing device, the operation target element corresponding to the image segment is detected from an event that the image segment is operated on the electronic equipment, and the processing step, which should be executed with respect to the operation on the operation target element, is carried out. Accordingly, in place of executing the processing step that should be executed with respect to the operation on the operation target element on the side of the electronic equipment, the information processing device can execute this processing step. Namely, the electronic equipment, if capable of detecting that the image segment is operated, can make the information processing device execute the processing step that should be carried out with respect to the operation on the operation target element corresponding to the image segment. The image transmitting unit may further transmit the image corresponding to a result of executing the processing step to the electronic equipment. This scheme enables the electronic equipment to receive, as the image, the result of executing the processing step.

The image transmitting unit may transmit an image corresponding to a result of executing the processing step to the electronic equipment at a predetermined time interval. This scheme enables the electronic equipment to receive the result of executing the processing step as the image at the predetermined time interval.

The processing step may be an operation request to a Web server on the Internet. This scheme enables the electronic equipment to receive, as the image, the result of making the operation request for the Web server in the information processing device.

The processing step may be an operation request to a computer program executed by the information processing device. This scheme enables the electronic equipment to receive, as the image, the result of making the operation request for the computer program in the information processing device.

The processing step may be an operation request for a computer program executed by another information processing device linking up with the information processing device. This scheme enables the electronic equipment to receive, as the image, the result of making the operation request for the computer program executed on another information processing device.

The information processing device may further comprise a compression unit compressing the image. The electronic equipment can therefore receive the result as the compressed image.

Further, another aspect of the present invention may be electronic equipment comprising: an image receiving unit receiving, from a server device, an image including an image segment of an operation target element to be operated by an operation unit; a display control unit displaying the image on an image display device: an operation detecting unit detecting that the image segment in any one of positions within the image is operated by an input device; and a detection information transmitting unit transmitting, to the server device, detection information showing that the image segment in the position is operated corresponding to the detection, wherein the image receiving unit, when the server device detects the operation on the operation target corresponding to the operation with respect to the image segment in the position, receives the image that transits due to the detection thereof.

With this scheme, the server device detects the operation on the operation target, corresponding to the operation on the image segment, and the image, which transits due to the detection thereof, can be received. Namely, the electronic equipment itself does not execute the process causing the transition of the image but can receive only the image of the result thereof.

The electronic equipment further comprise, the image information being compressed in a predetermined format, an expansion unit expanding the received image information.

It is feasible to realize the processing environment of the computer capable of providing, in the electronic equipment having the lower throughput and the less number of usable functions than the normal computer, the higher performance and more of functions than the electronic equipment.

### BRIEF DESCRIPTION OF THE DRAWINGS

FIG. 1 illustrates a function block diagram showing an architecture of an information system according to one embodiment;

FIG. 2 is a diagram illustrating an example of image processing executed in an information system.

FIG. 3 is a flowchart illustrating a processing example in such a case that coordinates are designated on a touch panel of electronic equipment;

FIG. 4 is a flowchart illustrating image data and a processing flow.

### DETAILED DESCRIPTION

An information system according to a preferred embodiment will hereinafter be described with reference to the drawings.

<System Architecture>

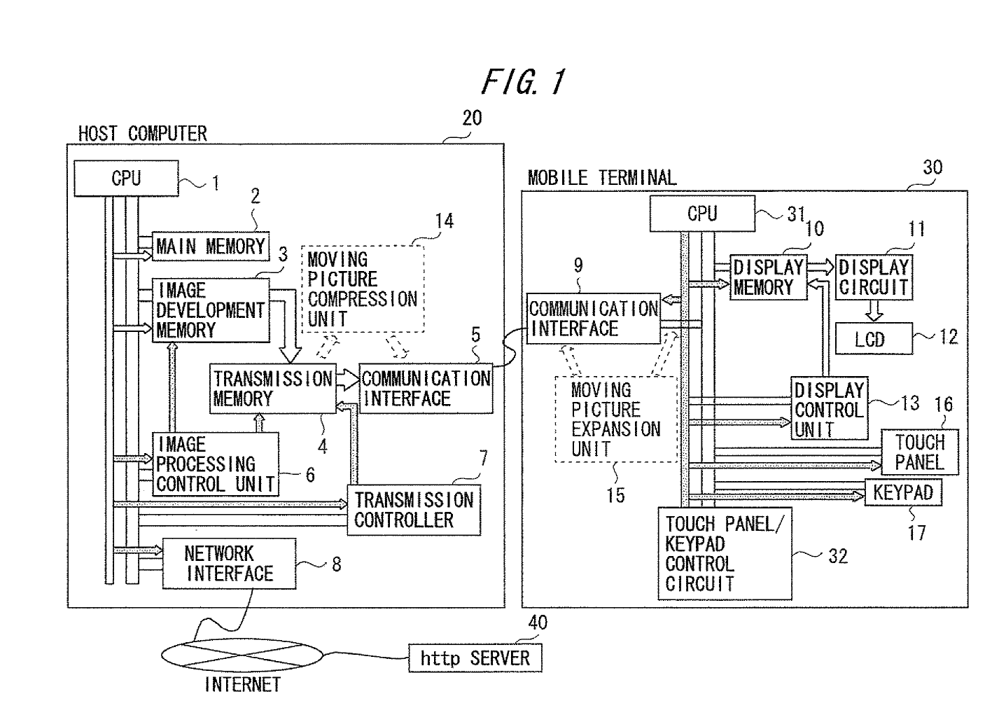

FIG. 1 illustrates a function block diagram showing a configuration of the present information system. As illustrated in FIG. 1, the information system is configured by a host computer 20 and mobile equipment (mobile terminal) 30 classified as electronic equipment, which accesses the host computer 20 via a wireless communication channel.

The mobile equipment 30 is exemplified by a mobile information terminal, a mobile phone, a PHS (Personal Handy-phone System), etc. As illustrated in FIG. 1, the mobile equipment 30 includes a CPU (Central Processing Unit) 31 that realizes an information processing function by executing an information processing program and a control program, a communication interface 9 having a wireless communication function, an expansion unit 15 which expands moving picture compressed data received via the communication interface 9, a display memory 10 stored with image data received via the communication interface 9, a display circuit 11 that generates a drive signal of LCD (Liquid Crystal Display) 12 from the image data stored in the display memory 10, the LCD 12 that is driven by the drive signal transmitted from the display circuit 11 and displays an image, a display control unit 13 that controls an input of the data to the display memory 10 and an output of the data from the display memory 10, a touch panel 16 (corresponding to an input device) which detects an input operation by a user, and a keypad 17 (corresponding to an input device).

The CPU 31 executes the information processing program and the control program, which are developed on an unillustrated memory, thereby realizing functions of the mobile equipment 30.

The communication interface 9 includes a wireless communication unit and accesses a base station and a backbone network of a network operator via the wireless communication channel. With this configuration, the communication interface 9 communicates with the host computer 20 connected to the base station of the network operator or with the host computer 20 connected to the backbone network of the communication carrier.

The moving picture expansion unit 15 (corresponding to an expansion unit) is a data processing unit that expands moving picture data compressed based on a variety of data formats (e.g., Windows Media (trademark) etc), H.264 (moving picture compression standards settled in collaboration by MPEG (Moving Picture Coding Experts Group/Moving Picture Experts Group) and ITU-T (International Telecommunication Union-Telecommunication Sector)), etc, which are advocated by, e.g., MPEG and OS vendors. In the implementation of the information system, the compression format of the moving picture data is not, however, restricted by the formats given above. Further, in the implementation of the information system, the moving picture expansion unit 15 is not indispensable element. Namely, in the implementation of the information system, the mobile equipment 30 may be built up, with a configuration including none of the moving picture expansion unit 15, to receive the uncompressed image data from the host computer 20.

The display memory 10 is a so-called VRAM (Video Random Access Memory) and retains the image data that should be displayed on the LCD 12. The display control unit 13 stores the image data received from the communication interface 9 in the display memory 10. The display circuit 11 reads the image data stored in the display memory 10 and generates a control signal for driving the LCD 12.

The LCD 12 (corresponding to a display device) displays the image data based on the control signal transmitted from the display circuit 11. The touch panel 16 is a transparent panel superposed on a display screen of the LCD 12. The touch panel 16, for example, when pressed downward from above the surface, generates an electric signal enabling a pressed position to be detected. Through this electric signal, the CPU 31 is notified of a coordinate value indicating the pressed position via a touch-panel/keypad control circuit 32. The CPU 31 notifies the host computer 20 of the coordinate value indicating the pressed position on the touch panel 16 via the communication interface 9.

The keypad 17 accepts character information inputted based on an operation that a user presses a key, and notifies the CPU 31 of the character information via the touch-panel/keypad control circuit 32. The CPU 31 transmits the character information, which has been notified via the touch-panel/keypad control circuit 32, to the host computer 20 via the communication interface 9.

The touch-panel/keypad control circuit 32 detects the electric signal generated by pressing the touch panel or the keypad, and specifies the coordinates of the position on the touch panel or a type of the key of the keypad. The OS, which controls the mobile equipment 30 via a device driver executed by the CPU 31 (the device driver and the OS correspond to an operation detecting unit), is notified of the information about the specified position coordinates or the specified key type.

The host computer 20 includes a CPU 1 that executes a computer program and thus provides functions as the host computer 20, a main memory 2 retaining the program executed by the CPU 1 and the data processed by the CPU 1, an image development memory 3 retaining the image data that may be displayed on the LCD 12, a transmission memory 4 functioning as a buffer for the data transmission, an image processing control unit 6 executing reduction or enlargement of the image on the image development memory 3, a moving picture compression unit 14 that compresses the image data on the transmission memory 4, a transmission controller 7 that controls storage of the image data in the transmission memory 4 and controls readout of the image to the moving picture compression unit 14 or a communication interface 5 from the transmission memory 4, and a network interface 8 that accesses a public communication network such as the Internet according to a standardized protocol of a LAN etc.

Among these components, the image development memory 3 and the transmission memory 4 are, e.g., the VRAMs and employed as buffers for retaining, processing and transmitting the images. The moving picture compression unit 14 (corresponding to a compression unit) is a component corresponding to the moving picture expansion unit 15 of the mobile equipment 30, and compresses the image data in a compression format (e.g., MPEG) corresponding to the moving picture expansion unit 15.

The communication interface 5 transmits and receives the data to and from the mobile equipment 30 via the wireless communication channel. The communication interface 5 may be configured as, e.g., a base station for the mobile phone. In this case, the communication interface 5 is constructed of a modulator-and-demodulator (MODEM), a transmission amplifier, a reception amplifier, a base station antenna, etc.

Note that an http server 40, which executes a Web server program for providing Web pages to a Web Browser executed by a computer in the Internet, resides in the Internet.

Herein, the host computer 20 executes, as by a general type of desktop PC etc, application programs such as the Browser. According to the present embodiment, the display data of the Browser executed by the host computer 20 is stored in the image development memory 3.

The readout from the image development memory 3 is controlled by the image processing control unit 6. To be specific, the image processing control unit 6 gives an address to the image development memory 3, reads the data, and writes the readout data to the transmission memory 4.

The readout from the transmission memory 4 is controlled by the transmission controller 7. Specifically, the transmission controller 7 gives a data readout address to the transmission memory 4. The readout data is transmitted to the communication interface 5.

The communication interface 5 transmits the data sent from the transmission memory 4 to the communication interface 9 of the mobile equipment 30.

In the mobile equipment 30, the received data is stored in the display memory 10 via the communication interface 9. The display control unit 13 gives a readout address to the display memory 10, and the data read from the display memory 10 is transmitted to and displayed on the LCD 12 via the display circuit 11.

The image processing control unit 6 reduces and enlarges the image in a way that changes a mode of how the addresses are given to the image development memory 3 and the transmission memory 4. Further, only a part of contents in the transmission memory 4 can be transmitted to the communication interface 5 by changing the address given to the transmission memory 4 from the transmission controller 7.

It is noted that the function blocks illustrated in FIG. 1 may be realized softwarewise owing to the improved performance of the CPU of the server device 20 (a personal computer etc).

<Example of Image Processing>

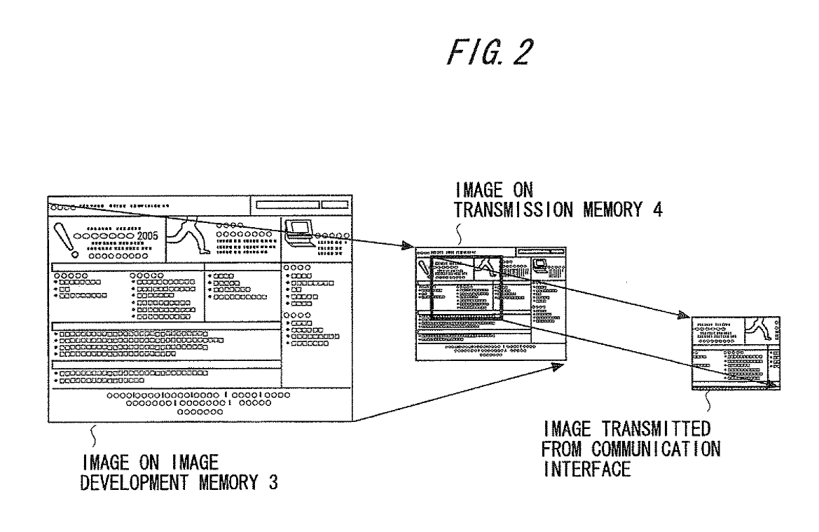

FIG. 2 shows an example of the image processing executed in the present information system. As described above, the CPU 1 of the host computer 20 executes, e.g., the Browser, and instructs the Browser to generate the image data, to be displayed on the screen, on the image development memory 3. In this case, through the execution of the Browser, the information provided by the http server 40 on the Internet is generated as the image data on the host computer 20. Further, the CPU 1 may also execute the application program such as a word processor and a spreadsheet program. In this case, image data configuring a user interface (operation screen) of the application program is generated by a local process on the host computer 20.

The CPU 1 requests other computers such as a database server, an image processor, a numeric processor extension (NPS) and a supercomputer to execute the process, and may store a processed result in the image development memory 3. To be specific, the CPU 1 issues an operation request for a computer program executed on another information processing device linking up with the host computer 20 to the another information processing device, then receives a result thereof and may transmits the processed result as an image to the mobile equipment 30.

The image processing control unit 6 executes the enlargement/reduction when storing the image in the transmission memory 4. Further, the image processing control unit 6 selects, e.g., a partial area of the image by clipping and may transfer the selected image to the communication interface 5. Thus, the whole or the partial area of the image generated by the Browser executed on the CPU 1 is transferred to the mobile equipment 30. Moreover, the whole or a partial area of the operation screen generated by the application program such as the word processor and the spreadsheet program, which is executed on the CPU 1, is transferred to the mobile equipment 30.

The mobile equipment 30 displays, on the LCD 12, the image data received via the communication interface and stored in the display memory 10. The image data is the image data that should be originally displayed by the display device of the host computer 20 and is also, e.g., the display data generated by the Browser executed on the host computer 20 or the image data configuring the operation screen for the word processor and the spreadsheet program.

On the other hand, in the mobile equipment 30, operation information inputted by the touch panel 16 and the keypad 17 is transmitted via the communication interface 9 to the host computer 20 and is processed by the host computer 20.

Specifically, the operation information transmitted from the mobile equipment 30 undergoes coordinate transformation corresponding to the image processing by the image processing control unit 6 or the transmission controller 7 etc, and is handed over to the application on the host computer 20, whereby the operation information is transformed into a mouse-input event on the Web content and mouse-input coordinates on the Browser. For example, in the mobile equipment 30, when the coordinates are inputted through the touch panel 16, the coordinate data (the coordinates of the position touched on the screen) is transmitted to the host computer 20. The host computer 20 transforms the coordinate data on the touch panel 16 into coordinates on the Web page, and transmits a mouse-click event about the coordinates to the Browser.

As illustrated in FIG. 1, a data quantity may be reduced by providing the moving picture compression unit 14 (depicted by the dotted line) based on MPEG, Windows Media (trademark), H.264, etc between the transmission memory 4 and the communication interface 5. In this case, the mobile equipment 30 also requires the moving picture expansion unit 15.

The present function is targeted, without being limited to the Browser display screen, at general display screens for application programs executable by the server device 20. In this case, the functions of the application programs executed by the server device 20 can be utilized on the mobile equipment 30.

<Processing Flow>

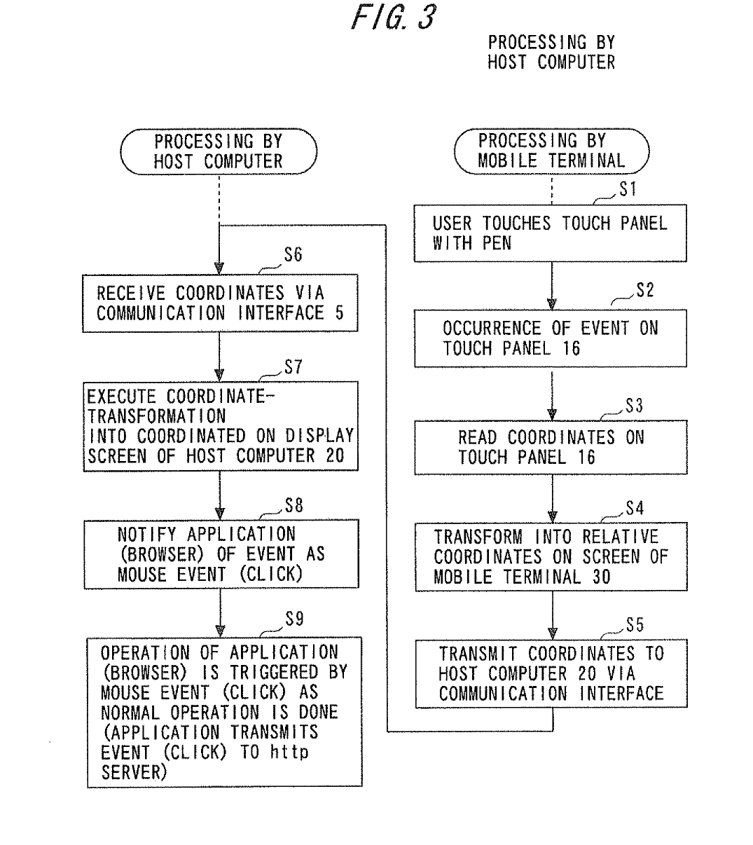

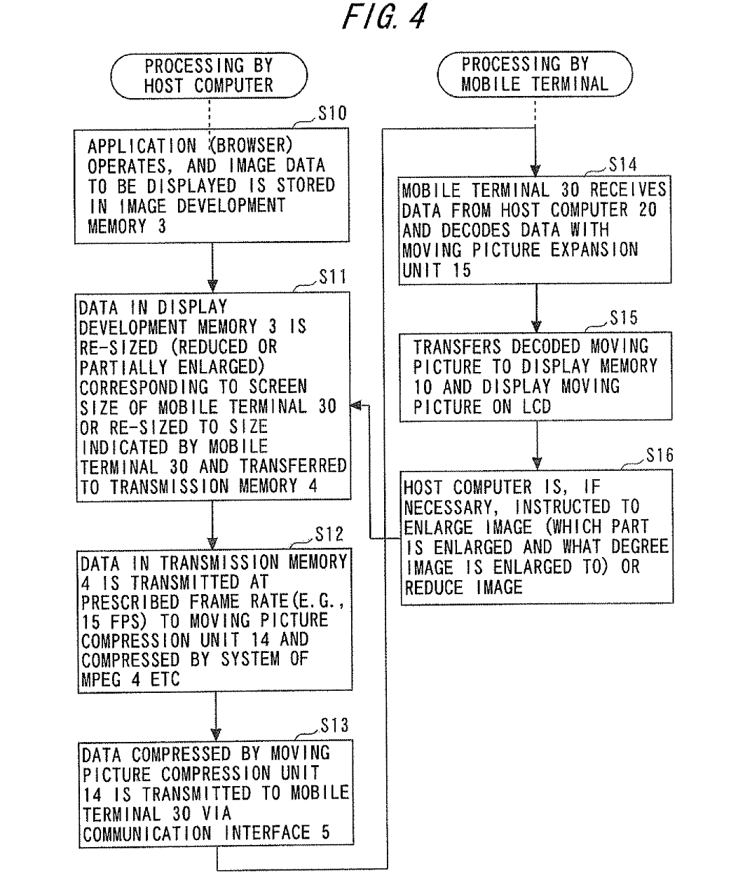

A processing flow of the present information system will be described with reference to FIGS. 3 and 4. FIG. 3 is a flowchart showing a processing example in a case where the coordinates are designated on the touch panel 16 of the mobile equipment 30. A premise is that the image based on the image data generated by the host computer 20 and developed on the transmission memory 4 is now displayed on the LCD 12 of the mobile equipment 30. The image is an image of the screen generated by the Browser executed on the CPU 1.

To begin with, the user touches the touch panel 16 with a pen (S1). Thereupon, the touch-panel/keypad control circuit 32 detects the electric signal generated in the touch panel 16, corresponding to the pressing operation on the touch panel 16, and detects the pressed position on the touch panel 16.

The device driver executed by the CPU 31 of the mobile equipment 30 recognizes the occurrence of the press on the touch panel 16 from the signal detected by the touch-panel/keypad control circuit 32. Namely, a touch-panel event occurs on the mobile equipment 30 (S2). The CPU 31 executing the process in S2 corresponds to an “operation detecting unit”.

Next, the device driver executed by the CPU 31 reads the coordinates of the pressed position on the touch panel 16 from the touch-panel/keypad control circuit 32 (S3). Further, the device driver transforms the readout coordinates into relative coordinates on the screen of the mobile equipment 30 (S4).

Subsequently, the communication control program is notified of the occurrence of the touch-panel event and the relative coordinates on the mobile equipment 30 via the OS executed by the CPU 31. The communication control program on the CPU 31 transmits the notified event-occurrence and the relative coordinates on the mobile equipment 30 to the host computer 20 via the communication interface 9 (S5). The CPU 1 executing the process in S5 corresponds to a “detection information transmitting unit”. Note that not the device driver but the application program on the OS may also transform the coordinates of the pressed position on the touch panel 16 into the relative coordinates on the screen of the mobile equipment 30.

In the host computer 20, the communication control program for managing the communications with the mobile equipment 30 is executed on the CPU 1. The CPU 1 receives radio signals from the communication interface 5 of the mobile equipment 30 via the communication interface 9. Then, the CPU 1 detects the occurrence of the event on the touch panel of the mobile equipment 30 and acquires the relative coordinates of the pressed position on the screen of the mobile equipment 30 (S6). The CPU 1 executing the process in S6 corresponds to a “detection information receiving unit”.

Next, the CPU 1 transforms the acquired relative coordinates on the mobile equipment 30 into relative coordinates on the display screen of the host computer 20 (S7).

Further, the CPU 1 generates a mouse-event on the host computer 20 and notifies the application program (e.g., Browser) of the mouse-event together with the relative coordinates transformed in S7 on the display screen of the host computer 20 (S8). The CPU 1 executing the processes in S7 and S8 corresponds to a “detection unit”.

The application program (e.g., Browser) recognizes that the screen (e.g., the display screen of a Website) is clicked by the mouse-event as the normal operation is done on the host computer 20, and transmits this event to the http server 40 on the Internet (S9). Thus, the user's operation on the mobile equipment 30 is transformed into the operation on the Browser of the host computer 20, and the http server 40 on the Internet is notified of this operation. The CPU 1 executing the processes in S8 and S9 corresponds to a “processing unit”.

FIG. 4 is flowchart of a processing flow showing how the image data is processed in the present information system. In the present information system, the application program runs on the CPU 1 of the host computer 20, and the image data to be displayed is stored in the image development memory 3 (S10).

The image data in the image development memory 3 is re-sized (reduced or enlarged) corresponding to a screen size of the mobile equipment 30 or to a screen size designated from the mobile equipment 30. Further, a part of the image data in the image development memory 3 may be clipped (cut off). Then, the resized or clipped image data is transferred to the transmission memory 4 (S11).

The data in the transmission memory 4 is read out to the moving picture compression unit 14 at a prescribed frame rate (e.g., 15 fps) and compressed based on, e.g., the MPEG system (S12). The image data compressed by the moving picture compression unit 14 is transmitted to the mobile equipment 30 via the communication interface 5 (S13). Thus the image in the image development memory 3, corresponding to the result of executing the application program, is transmitted to the mobile equipment 30 at the predetermined time interval of the frame rate. The CPU 1 executing the process in S13 corresponds to an “image transmitting unit”. Note that a part of the data in the transmission memory 4 may be, on the occasion of the transmission, clipped and transmitted by controlling the readout address.

The mobile equipment 30 receives the data from the host computer 20 (the CPU 31 executing this data receiving process corresponds to an “image receiving unit”), and decodes the received data into the image data in the moving picture expansion unit 15 (S14). The mobile equipment 30 transfers the decoded image data as a moving picture to the display memory 10 and displays the moving picture on the LCD (S15). The CPU 31 executing the process in S15 corresponds to a “display control unit”.

The user executes the operation of enlarging or reducing the image according to the necessity. The CPU 31 of the mobile equipment 30 detects the user's operation with the touch-panel/keypad control circuit 32 (the CPU 31 executing this detection process corresponds to an “operation detecting unit”), and transmits the detected operation to the host computer 20 through the wireless communications via the communication interface 9. For example, pieces of information for instructing which part is enlarged and what degree the enlargement thereof is done to, are transmitted to the host computer (the CPU 31 executing this process corresponds to a “detection information transmitting unit”).

Further, the user operates an operation target (a menu or an icon, etc) in the image displayed on the mobile equipment 30. Then, coordinates of the operated position are transmitted together with the event specifying the operation to the host computer 20.

The host computer 20 transforms the received coordinates of the position into the relative coordinates on the host computer 20 (alternatively into the relative coordinates on the being-executed application program). Then, the host computer 20 specifies the operation target in the image from the thus-transformed relative coordinates.

On the other hand, the user sees, via the LCD 12, changes on the screen generated by the application program being executed by the host computer 20 as if watching a TV picture, thus recognizing the images transmitted from the server device 20. When the user operates the operation target on the LCD 12 with the touch panel 16 or the keypad 17, a corresponding event on the screen occurs in the host computer 20, and it follows that the screen on the LCD 12 transits.

<Effects of the Embodiment>

As discussed above, according to the information system in the present embodiment, the Browser function, which is hard to be realized hardwarewise, is executed by the host computer 20 having the high-performance CPU on the network, and the image data on the screen generated as a result of this execution is transmitted as the moving picture to the mobile equipment 30 via the network. This scheme enables the highly-functional Internet browsing to be done on the mobile equipment 30. The prior arts could not support these functions with the limited resources of the mobile equipment 30. Namely, the mobile equipment 30 can utilize, for example, high-speed processing owing to the high-performance of the CPU 1, a quick display function owing to taking more of cache memories, a plug-in function of the Browser that is developed for only the desktop type, a Web-oriented animation generating program (e.g., Macromedia Flash (trademark)), an image data display program (e.g., a PDF Viewer), a moving picture decoding function, a word processor, a spreadsheet program, a presentation material creating tool and other document display functions.

Further, the mobile equipment 30 can perform HTML (HypertText Markup Language) browsing (Internet surfing) without implementing the HTML Browser.

Still further, not only the (HTML) contents on the Internet but also all the contents, which are displayable by the host computer 20 and transmissible to the mobile equipment 30, can be displayed on the mobile equipment 30.

In this case, the mobile equipment 30 may simply execute only the process of detecting the user's operation and notifying the host computer 20 of the detected operation as event and the process of displaying the image data transmitted as the moving picture from the host computer 20. Accordingly, the mobile equipment 30 has no necessity of executing the individual application programs such as the Browser, the word processor and the spreadsheet program.

Moreover, in the present embodiment, the mobile equipment 30 simply displays the images, as the moving picture, generated by the host computer 20 and is not required to generate the images. Namely, the mobile equipment 30 has no necessity of interpreting a rendering command given from the server side (host computer 20) and generating the images as by a general type of client/server model system. Therefore, if capable of providing the display memory 10 and the display circuit 11 which display the images, an intelligent/multifunction environment can be realized on the mobile equipment 30 by utilizing the resources of the host computer 20.

<Readable-by-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. In these mediums, the components such as the CPU and the memory that build up the computer are provided, and the CPU may be made to execute the program.

Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

What is claimed is:

1. An information processing device comprising:
an image transmitting unit transmitting an image including an image segment of an operation target element that is displayed and operated on electronic equipment to said electronic equipment;
a detection information receiving unit receiving detection information indicating that the image segment is operated on said electronic equipment;
a detecting unit detecting an operation on the operation target element corresponding to the image segment from the detection information; and
a processing unit executing a processing step that should be executed with respect to the operation on the operation target element.

2. The information processing device according to claim 1, wherein said image transmitting unit further transmits an image corresponding to a result of executing the processing step to said electronic equipment.

3. The information processing device according to claim 1, wherein said image transmitting unit transmits the image corresponding to the result of executing the processing step to said electronic equipment at a predetermined time interval.

4. The information processing device according to claim 1, wherein the processing step is an operation request for a Web server on the Internet.

5. The information processing device according to claim 1, wherein the processing step is an operation request for a computer program executed by said information processing device.

6. The information processing device according to claim 1, wherein the processing step is an operation request for a computer program executed by another information processing device linking up with said information processing device.

7. The information processing device according to claim 1, further comprising a compression unit compressing the image.

8. The information processing device according to claim 1, wherein said image transmitting unit transmits, to said electronic equipment, an image to be displayed as the image on a screen generated by executing a computer program running on said information processing device.

9. Electronic equipment comprising:
an image receiving unit receiving, from a server device, an image including an image segment of an operation target element to be operated by an operation unit;
a display control unit displaying the image on an image display device:
an operation detecting unit detecting that the image segment in any one of positions within the image is operated by an input device; and
a detection information transmitting unit transmitting, to said server device, detection information showing that the image segment in the position is operated corresponding to the detection,
wherein said image receiving unit, when said server device recognizes an operation on the operation target element with respect to the image segment in the position, receives the image that transits due to the detection thereof.

10. The electronic equipment according to claim 9, further comprising, the image information being compressed in a predetermined format, an expansion unit expanding the received image information.

11. The electronic equipment according to claim 9, wherein said image receiving unit receives an image to be displayed as the image on a screen generated by executing a computer program running on said server device.

12. An information processing device comprising:
a transmitting unit transmitting, to electronic equipment, data containing a portion of an operation target element that is displayable on said electronic equipment and operated on said electronic equipment;
a detection information receiving unit receiving detection information showing that the portion is operated on said electronic equipment;
a detecting unit detecting an operation on the operation target element corresponding to the data portion from the detection information; and
a processing unit executing a processing step that should be executed with respect to the operation on the operation target element.
